(19) United States
(12) Patent Application Publication
(10) Pub. No.: US 2020/0247471 A1
(43) Pub. Date: Aug. 6, 2020

(54) VEHICLE PARK ASSIST SYSTEMS

(71) Applicant: CARIT AUTOMOTIVE GMBH & CO. KG, Muenster (DE)

(72) Inventor: Guenter GRODDE, Muenster (DE)

(21) Appl. No.: 16/797,102

(22) Filed: Feb. 21, 2020

Related U.S. Application Data
(63) Continuation of application No. PCT/IB2019/000078, filed on Feb. 1, 2019.

(51) Int. Cl. B62D 15/02; B62D 13/06; B60W 10/20; B60W 50/04; B60R 11/04; H04L 12/40

(52) U.S. Cl. CPC B62D 15/0275; B62D 15/028; B62D 13/06; B60W 2050/0064; B60W 50/045; B60R 11/04; H04L 12/40013; B60W 10/20

(57) ABSTRACT

A vehicle-trailer system is disclosed. The system utilizes a controller that has a processor, a global positioning system that provides a geographic position to the processor, a data transmission device that sends and receives data through the controller and a camera signal encoder. The system also includes various three-dimensional (3-D) position sensors, which measure changes in spatial position with reference to location on three axes (e.g., 3-D compass comprising a magnetometer, a gyroscope, and an accelerometer). Moreover, the system comprises a vehicle network bus reader that communicates vehicle information from the vehicle network bus to the controller (e.g., controller area network (CAN) bus, or a local interconnect network (LIN) bus) wherein the controller is capable of communicably coupling to a remote client device, the remote client device configured to convey steering instructions.

### CROSS REFERENCE TO RELATED APPLICATIONS

This application is a bypass continuation of International Application No. PCT/IB2019/000078, filed Feb. 1, 2019, entitled VEHICLE PARK ASSIST SYSTEMS, the disclosure of which is hereby incorporated herein by reference.

### BACKGROUND

Various aspects of the present disclosure relate generally to vehicle-assisted systems, and specifically guidance of vehicle-assisted trailers.

Vehicles such as cars, trucks, and vans are used to transport people and miscellaneous items across varying distances. In some cases, certain vehicles have a finite amount of storage space. One potential solution to supplement that finite storage space is through utilization of trailers. Trailers come in many shapes and sizes that can accommodate various needs of the user such as horse trailers, bicycle trailers, motorcycle trailers, boat trailers, and semi-truck trailers.

### BRIEF SUMMARY

According to aspects of the present disclosure, a trailer park-assist system is disclosed. The system utilizes a controller that has a processor, a global positioning system that provides a geographic location to the processor, and a data transmission device that sends and receives data through the controller. The system also includes two (or more) 3-dimensional (3-D) sensors (as common mode for noise elimination), which independently measure changes in spatial position on all three axes (e.g., 9-D Inertial Module comprising a 3-D magnetometer, a 3-D gyroscope, and a 3-D accelerometer). For purposes of clarity and simplicity, multiple sensors may be referred to as a single sensor. Moreover, the system comprises a vehicle network bus reader that communicates vehicle information from the vehicle network bus to the controller (e.g., controller area network (CAN) bus, a local interconnect network (LIN) bus, etc.), wherein the controller is capable of communicably coupling to a remote client device that is configured to convey steering instructions.

According to further aspects of the present disclosure, a computer implemented process for guiding a vehicle-assisted trailer is disclosed. Generally, the process includes receiving output from a first three-dimensional sensor in the trailer and a second three-dimensional sensor that couples to the controller on the vehicle. Examples of components associated with the controller are a processor, a global positioning system (“GPS”, e.g., tri-angulation, geo-magnetic based, etc.), a global navigation satellite system (“GNSS”, e.g., Galileo, the European navigation system (used interchangeably with “GPS” for ease of clarity)), a data transmission device, and a vehicle network bus reader. The controller transmits select output(s) from two 3-D position sensors to a remote client device to define a starting position, an ending position, or both. The starting position and the ending position are used to calculate a custom path that the vehicle and trailer traverse.

Once the custom path is calculated, tracking data of the vehicle plus the trailer system is acquired by utilizing the two 3-D sensors and the GPS information as the vehicle and trailer traverse from the starting position to the ending position along the custom path. Moreover, steering instructions are conveyed (or generated) on the remote device based on tracking data and the custom path until the vehicle and trailer arrive at the ending position.

Yet further, a computer implemented process for guiding a vehicle (without a trailer) is disclosed. The process includes receiving, by a controller, output from a first 3-D position sensor that couples to a vehicle and a second 3-D sensor with one or more cameras located at the front, the back, or both of the vehicle coupled to the vehicle. The controller can utilize various components such as a processor, a global positioning system, a data transmission device, a vehicle network bus reader, and camera signal encoders. Images of the environment are captured by camera sensors, and those images along with 3-D position data are transmitted to a remote client device. Further, a starting position and an ending position is defined on the remote client device in order to calculate (i.e., create) a custom path. As the vehicle moves along the custom path, tracking data related to the vehicle is acquired, and steering messages are conveyed (or generated) until the vehicle arrives at the ending position. Certain implementations of the system allow for implementation of the system in autonomous vehicles.

Moreover, a second system for guiding a vehicle-assisted trailer is disclosed. The system uses a remote client device having a graphical user interface (GUI), a controller, and a processor. The remote client device is configured to accept positional data from a vehicle and a trailer (e.g., GPS location, orientation of the trailer and the vehicle such as pitch, roll, and yaw, etc.) and display, on the GUI, a representation of a vehicle and a trailer within an environment based on the positional data. A user of the remote client device can then input or create a starting position and an ending position on the GUI.

The system further includes discriminating between a forbidden area and an acceptable area within the environment, calculating a shortest line path between the starting position and the ending position, and verifying whether the shortest line path intersects with the forbidden area. If the shortest line path does not intersect with the forbidden area, the system may convey (or generate) steering instructions on the GUI, based on the positional data, as the vehicle and trailer traverse from the starting position to the ending position along the shortest line path.

If the shortest line path intersects with the forbidden area, the system superimposes an overlay grid on the representation of the vehicle and the trailer within the environment, wherein each grid point within the overlay grid is associated with a position in the environment. Further, the system excludes grid points that are within the forbidden area and modifies the shortest line path to correspond with grid points within the acceptable area within the environment, thus creating a custom path. Accordingly, steering instructions are conveyed (or generated) on the GUI, based on the positional data, as the vehicle and trailer traverse from the starting position to the ending position along the custom path. Certain implementations of the system allow for implementation of the system in autonomous vehicles.

### BRIEF DESCRIPTION OF THE SEVERAL VIEWS OF THE DRAWINGS

FIG. 1 is a structural diagram (i.e., topology) of an example vehicle-assisted trailer system, according to various aspects of the present disclosure;

FIG. 2 is an example embodiment of the system of FIG. 1 when implemented on a trailer and a vehicle, according to various aspects of the present disclosure;

FIG. 3 is a flow chart of a computer implemented process for guiding a vehicle-assisted trailer, according to various aspects of the present disclosure;

FIG. 4A is an illustration of a graphical user interface in an example embodiment of a computer implemented process for guiding a vehicle-assisted trailer, according to various aspects of the present disclosure;

FIG. 4B is a further illustration of the graphical user interface example embodiment of FIG. 4A, according to various aspects of the present disclosure;

FIG. 4C is a further illustration of the graphical user interface example embodiment of FIG. 4B, according to various aspects of the present disclosure;

FIG. 4D is a further illustration of the graphical user interface example embodiment of FIG. 4C, according to various aspects of the present disclosure;

FIG. 5A is an illustration of a graphical user interface in an example embodiment of creating and using a custom path according to various aspects of the present disclosure;

FIG. 5B is a further illustration of the graphical user interface of FIG. 5A according to various aspects of the present disclosure;

FIG. 5C is yet further illustration of the graphical user interface of FIG. 5B according to various aspects of the present disclosure;

FIG. 5D is yet further illustration of the graphical user interface of FIG. 5C according to various aspects of the present disclosure;

FIG. 5E is an illustration of the graphical user interface of FIG. 5D displaying a rear view behind a vehicle that is moving along the custom path according to various aspects of the present disclosure;

FIG. 5F is a visual illustration of equipment on the trailer of FIG. 5A using positional information to adapt to a change of an ending point.

FIG. 6 is a flow chart of a computer implemented process for guiding a vehicle, autonomously, according to various aspects of the present disclosure;

FIG. 7 is an example embodiment of a vehicle and associated hardware that can be used in the process of FIG. 6, according to various aspects of the present disclosure;

FIG. 8 is a flow chart of a system for guiding a vehicle-assisted trailer, according to various aspects of the present disclosure;

FIG. 9 is an angular model illustrating a circulating state, according to various aspects of the present disclosure;

FIG. 10 is a kinematic model for off-angle hitching, according to various aspects of the present disclosure;

FIG. 11 is an angular model for a trailer on path stabilization utilizing a forward-looking path, according to various aspects of the present disclosure; and

FIG. 12 is a motion control block diagram with respect to hitch angle adjustments, according to various aspects of the present disclosure.

### DETAILED DESCRIPTION

Aspects of the present disclosure provide for systems and computer-implemented processes to modify and improve the technology field of vehicle-assisted systems, including vehicle-assisted trailers. For example, in a situation where a boat is on a trailer, and the trailer is coupled to a vehicle, backing the boat into a dock can be difficult if the boat is large enough to obscure a driver's vision of the dock or if there is an obstruction between the dock and the vehicle/trailer. Accordingly, certain aspects of the present disclosure may help the driver navigate through difficult or unseen paths as described in greater detail herein.

Previously proposed solutions in this technological field have used a two-dimensional (2-D) (e.g., x-axis and y-axis) approach to guide a vehicle-assisted trailer. However, such solutions may not be equipped to account for slopes, hills, or navigate around obstructions and blind corners.

For example, in select existing solutions a bend angle sensor is placed where the trailer couples to the vehicle. The bend angle sensor is used in conjunction with an angular position of a steering wheel to mathematically calculate a path (e.g., using the Ackermann Model) that is dictated to a driver of the vehicle. However, in such implementations, being limited to one set of positional data (i.e., data from the bend angle sensor) may make it difficult for the system to account for slopes, hills, or navigate around obstructions and blind corners.

Conversely, aspects of the present disclosure are directed toward a three-dimensional (3-D) (e.g., x-axis, y-axis, z-axis) approach. Whereas the 2-D approach may be limited to a level (or substantially level) surface, the 3-D approach disclosed herein does not share that limitation. Rather, the 3-D approach allows navigation where slopes and other changes of elevation may be a factor.

Many implementations of the present disclosure utilize a nine-axis compass (or 9-D inertial module unit (IMU)), which comprises a three-axis magnetic compass, a three-axis gyroscope, and a three-axis accelerometer. The 9-D IMU measures and captures complex motion data in multiple directions through multiple technologies, which may be used to determine an actual position or orientation of an object (e.g., a trailer coupled to a vehicle).

Further, implementing more than one 9-D IMU can provide further benefits. For example, by placing one 9-D IMU sensor on the vehicle and the other 9-D IMU sensor on the trailer allows for independent tracking of the vehicle and the trailer, which provides more accurate positional information and better guidance on terrain with elevation changes.

Moreover, in various implementations, inclusion of a global positioning system and a remote client device with a graphical user interface (GUI) including map data allows a driver to plot or navigate around objects and blind corners. Further benefits, advantages, and solutions relating to aspects of the present disclosure are provided in greater detail herein.

Trailer Park-Assist System Overview

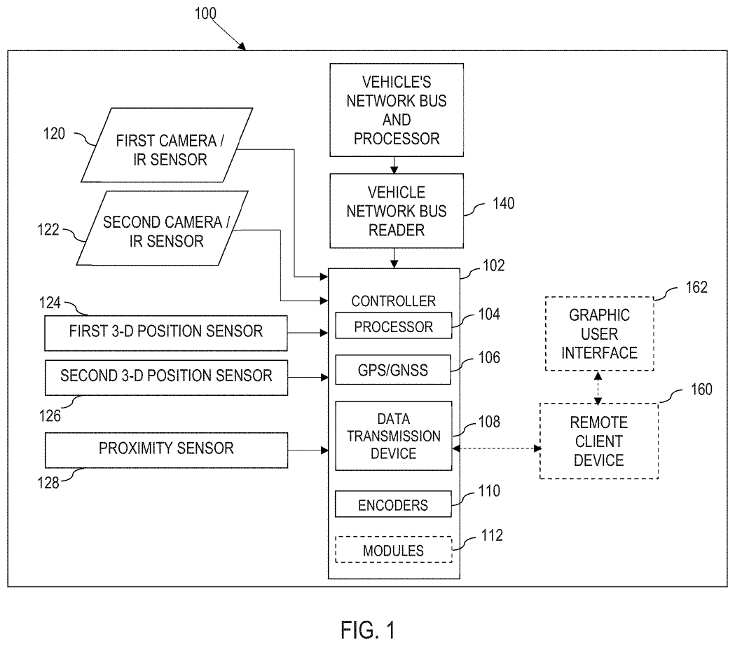

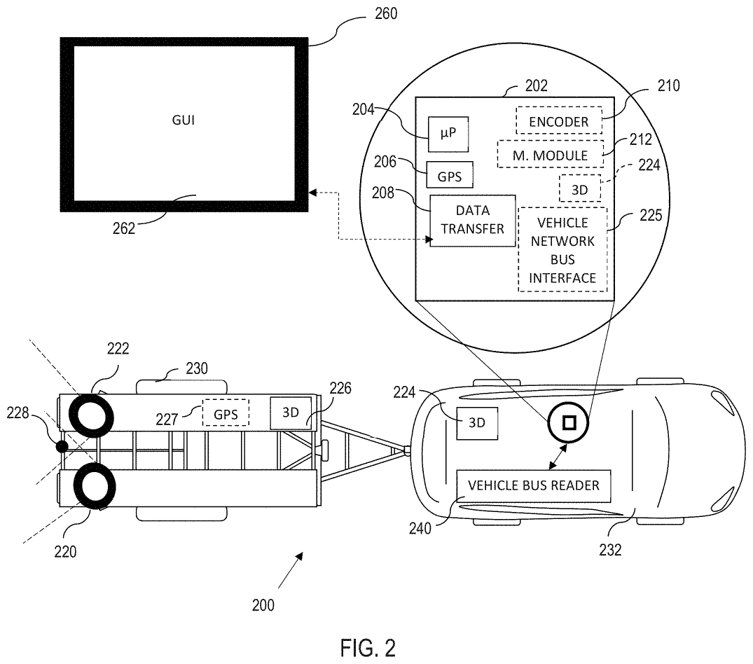

Now referring to FIG. 1, a structural diagram (i.e., topology) of an example vehicle-assisted trailer system 100 according to various aspects of the present disclosure. The system 100 comprises a controller 102 having a processor 104 (including sufficient memory sufficient to carry out required functions), a global positioning system (e.g., GPS and/or global navigation satellite systems (GNSS)) 106 that provides a geographic location to the processor 104 (e.g., a high precision GPS accurate to less than 10 cm (centimeter)), and a data transmission device 108 that receives data sent to the controller 102 and transmits data sent from the controller 102 (i.e., data to and from various components of the system 100). While FIG. 1 illustrates the GPS 106 as being a component of the system, the GPS may be external to the system such that the externally located GPS 106 sends data to the system 100. Further, the GPS 106 may be on a separate board of the system 100 (see FIG. 2). As used herein, a geographic location is a location, while a spatial position includes a location and an orientation.

Examples of data transmission devices include local area networks (LAN), wireless local area networks (WLAN), Bluetooth low energy (BLE), or global systems for mobile communication (GSM). The controller may also comprise various encoders such as a camera signal encoder 110. In various embodiments, the controller 102 can have various modules such as a motion module 112 (e.g., dual-3-D/9-D motion).

In various embodiments of the system 100, the controller 102 is configured to capture image data of a first area of interest by a first camera sensor 120 that communicably couples to the controller 102. The first camera sensor 120 can capture and transmit the image data of the first area of interest to the controller 102, wherein when installed, the first camera sensor 120 couples onto a posterior side of the trailer (e.g., a license plate mounted camera). In embodiments that use the first camera 120, the controller 102 may utilize various encoders 110 (e.g., a camera signal encoder).

For the purposes of this disclosure, a camera signal encoder is a device or software that converts images/video from one format or data type, to another format or data type (e.g., a 4-channel differential input video decoder/encoder). Examples of conversion using a camera signal encoder include, but are not limited to analog to digital, or digital data formatted in a specific file type converted to another specific digital file type (e.g., in NTSC (National Television System Committee) or PAL (phase alternating line) format).

In further implementations, the controller 102 may be configured to capture image data of a second area of interest by a second camera sensor 122 that communicably couples to the controller 102. The second camera sensor 122 captures and transmits the image data of the second area of interest to the controller 102, wherein when installed, the second camera sensor couples 122 onto the posterior side of the trailer, between the vehicle and the trailer, the front of the vehicle, or combinations thereof. Alternatively, the second camera sensor 122 can be paired with the first camera sensor 120 on the posterior of the trailer.

In this regard, the first camera sensor 120, the second camera sensor 122, or a combination thereof may be a stereo camera, a digital camera, an infrared camera, or any suitable image capturing device capable of transmitting image data of the areas of interest to the controller 102. Further, the first camera sensor 120 and the second camera sensor 122 may have image recognition that can detect people or objects. The images captured by camera sensors may be single images, a series of images, or a video (e.g., real-time video streaming, ideally with a latency less than 100 milliseconds (ms), but no greater than 500 ms). Moreover, the camera sensors can measure the distance between the applicable camera sensor and any structures behind the trailer (e.g., via image recognition or proximity sensors).

Moreover, the system 100 comprises a first three-dimensional (3-D) position sensor 124 that communicably couples to the controller 102, which measures changes in spatial position on three axes, and when installed, the first 3-D position 124 sensor couples to a vehicle.

Additionally, the system 100 comprises a second 3-D position sensor 126 that communicably couples to the controller 102, which measures changes in spatial position on three axes, and when installed, the second 3-D position sensor 126 couples to a trailer.

The 3-D position sensors 124 and 126 can each be integrated into a printed circuit board (PCB) or may stand-alone and connect to the controller 102 (e.g., by a wiring harness configured to supply power to the various components of the system 100).

For the purpose of this disclosure, a 3-D position sensor is a sensor that can measure or detect changes in position on three axes (e.g., x-axis, y-axis, z-axis). In various embodiments, the applicable 3-D position sensor comprises a magnetometer, an accelerometer, and a gyroscope (e.g., a nine-axis (or 9-D) IMU as described above). In such embodiments, not only can the 3-D position sensor measure or detect changes on three axes but can also measure rotation on each of the three axes. For the purpose of this disclosure, 3-D and 9-D sensors and IMUs can be used interchangeably.

In multiple embodiments, the system 100 further comprises a proximity sensor 128 that communicably couples to the controller 102, which captures and transmits environmental spatial data to the controller, wherein when installed, the proximity sensor couples onto the posterior side of the trailer.

Further, the system 100 comprises a vehicle network bus reader 140 that communicably couples to the controller 102 and a vehicle network bus of the vehicle, wherein when installed, the vehicle network bus reader 140 communicates vehicle information from the vehicle network bus to the controller 102.

The vehicle network bus reader 140 interfaces with various vehicle systems such as a control area network (CAN) bus, or local interconnect network (LIN) bus. No particular interface method is required. The vehicle network bus reader 140 may be hardwired into the vehicle network bus, or an inductive vehicle network bus reader can be used. Inductive readers can effectively “listen” to the exchange of information in a vehicle network without a physical connection to the wires. Examples of information that can be obtained by the reader includes data about engine running modes, sensors conditions, troubleshooting, etcetera.

Practically speaking, the system 100 and the controller 102 may be exposed to moisture or other adverse environmental conditions. Accordingly, a protective component such as a housing may be used. Examples for suitable housing for the controller 102 and its various components include but are not limited to ingress protection 67 (IP67 housing, IP54 housing, etc.).

In various embodiments, the system 100 further comprises a remote client device 160 that may further comprise a graphical user interface 162. In such embodiments, the remote client device 160 can receive user inputs, communicate with the controller 102, and allow a user of the remote client device 160 to customize the behavior of the overall system 100 as described in greater detail below.

Examples of a remote client device 160 include but is not limited to a mobile device (e.g., cellular phone, a stand-alone GPS unit, etc.) with a touch screen interface and an interface within the vehicle (e.g., built-in dashboard interface). The remote client device 160, when implemented, can be configured to convey steering instructions to a user of the system 100 as described in greater detail herein.

In certain instances, the remote client device 160 may have a more powerful processor than the controller 102 (e.g., a smartphone). In such instances, the remote client device 160 can handle most, if not all of the processing requirements of the system 100.

Utilizing the remote client device's 160 processor instead of the processor 104 on the controller 102 has many potential benefits. For example, there may be a reduced cost to the overall system 100 by utilizing lower cost hardware (e.g., a lower cost processor for the controller). Further, certain remote client devices 160 such as smartphones are usually internet accessible, which may provide an avenue to conveniently update the remote client device 160. Additionally, the system 100 may be configured so that only one remote client device 160 may be connected to the controller 102.

In various embodiments, the remote client device 160 further comprises a user profile that is configured to accept data input relating to physical dimensions of at least one of a length of the vehicle, a width of the vehicle, a width of the trailer, a length of the trailer, a distance between a front axle and a rear axle of the vehicle, distance between a front axle and a rear axle of the trailer, and a distance between the vehicle and the trailer.

Additionally, the controller 102 may be configured to transmit the image data of the areas of interest from the data transmission device 108 to the remote client device 160 via the data transmission device 106.

The controller 102 may also be configured to transmit steering instructions to the remote client device 160 based on the vehicle information communicated by the vehicle bus network reader 140, the image data of the first area of interest, and the geographical position tracked by the global positioning system 106. Examples of the user inputs are described in greater detail herein.

Examples of Hardware Configurations

1. A vehicle module having 9-axis IMU (3-D accelerometer, 3-D gyroscope, and 3-D magnetic compass), 12 V power circuitry, CAN bus Interface, and IP54 housing.

2. A vehicle resident inductive CAN bus reader connected to the vehicle CAN controller.

3. A trailer module having an NXP iMX6 processor, Linux operating system, custom embedded software, 9-axis IMU (3-D accelerometer, 3-D gyroscope, and 3-D magnetic compass), high-precision GPS module (premium option), Wi-Fi connection, analog camera interfaces with video signal encoding, CAN bus controller, 12 V power circuitry, connector interface, and IP67 housing.

4. Two analog infrared cameras with IR LED assembly (e.g., license plate mount type).

5. Wiring harnesses for the trailer module (e.g., 4 wires: 1×12 V, 1×ground, 2×analog camera inputs), cameras (e.g., 3 wires: 1×12 V, 1×ground, 1×video), vehicle module (e.g., 4 wires: 1×12 V, 1×ground, 1×CAN high, 1×CAN low), inductive CAN bus reader cable (already part of reader module).

6. Custom application for trailer camera video, steering support messages, overlaid vehicle front wheels, trailer trajectory, additional optional messages (e.g. app active, speed etc.), etc.

Trailer Park-Assist System Example Layout(s)

FIG. 2 illustrates an example embodiment 200 of the system 100 when installed onto a trailer 230 and a vehicle 232. Unless stated otherwise, the numbered components of FIG. 2 match the numbered components of FIG. 1, including the definitions and embodiments thereof, except that the numbers in FIG. 2 are 100 higher.

In FIG. 2, a controller 202 installed on the vehicle 232. However, the controller 202 may be installed on the trailer 230 instead of the vehicle 232. Installing the controller 202 on the vehicle 232 is generally preferred since it allows for less hardware on the trailer 230 and may yield better performance (i.e., CAN signals do not have to be transmitted wirelessly to the controller 202 from the trailer 230). In this example, the controller 202 is on the vehicle 232, ideally close to the vehicle's CAN bus and power interface (e.g. under the dash and switched on via ignition).

Analogously to the system 100, the controller 202 comprises a processor 204, a GPS and/or GNSS 206 (as mentioned above, the GPS may be separate from the board), a data transmission device 208, and encoders 210. Further, the controller 202 communicably couples with a vehicle network bus reader 240. In various embodiments, the controller 202 further comprises motion module(s) 212.

Moreover, a first camera sensor 220 and a second camera sensor 222 are placed on the trailer 230 in various configurations (an example field of view for each camera sensor is illustrated by, but not limited to, the dashed lines emanating from the camera sensors 220, 222). In this particular embodiment, the camera sensors 220 and 222 are both positioned on the posterior of the trailer 230. In alternate embodiments, the second camera sensor 222 may be placed between the vehicle 232 and the trailer 230 to monitor the connection between the vehicle 232 and the trailer 230 (e.g., a trailer load camera).

In addition, a first 3-D position sensor 224 and a second 3-D position sensor 226 are placed on the vehicle 232 and the trailer 230 (i.e., one 3-D position sensor each). The differential signal between the first 3-D position sensor 224 and the second 3-D position sensor 226 is used to calculate the relative orientation angle (i.e., hitch angle) between vehicle 232 and trailer 230 without a need for a designated angle sensor at the hitch point itself. The 3-D position sensors 224 and 226 do not have a strict placement requirement within the vehicle 232 and the trailer 230. However, it may be preferable for positional accuracy purposes to place one 3-D position sensor on a back of the trailer 230 and one 3-D position sensor at a front end of the vehicle 232. In various embodiments, the first 3-D position sensor 224 may be integrated into the controller 202 directly (as shown dashed lines), as opposed to stand-alone. Moreover, proximity sensors 228 may be included. Further, the controller board 202 may include a vehicle network bus (e.g., controller area network (CAN) bus, local interconnect network (LIN) bus, etc.) interface, so the controller board 202 may communicate with systems of the vehicle.

In various embodiments, a second GPS sensor 227 may be utilized to further increase positional accuracy via full differential calculations between the GPS sensors (as opposed to a partial differential from a single GPS sensor 227, where the position of the trailer 230 is derived from the GPS location of the vehicle 232). For example, the second GPS sensor may be placed on the trailer as shown in FIG. 2 in dashed lines.

### Calibration Example 1

Under certain implementations of the present disclosure, it may be possible to further increase positional accuracy through calibration of the 3-D position sensors 224 and 226. For example, the 3-D position sensors 224 and 226 may self-calibrate the hitch angle between vehicle 232 and trailer 230 while the vehicle 232 and the trailer 230 are in motion (i.e., calibrate “on the go”). One example of on the go calibration is through utilization of a learning algorithm (e.g., by calculating the relative angle between the trailer 230 and the vehicle 232 using perpendicular acceleration). In particular, at concurrent zero perpendicular acceleration of the trailer 230 and the vehicle 232, a linear motion of the complete system can be identified for calibrating a 180-degree hitch angle. The learning algorithm may further be configured to re-calibrate upon fulfillment of various conditions (e.g., a different weight load or a different trailer is detected). Moreover, the learning algorithm may determine a maximum angle (i.e., a critical hitch angle) that the vehicle 232 may have in relation to the trailer 230 before a jackknife accident occurs, and implement various actions based on the maximum angle as described in greater detail herein.

### Calibration Example 2

Alternatively, the user may choose to calibrate the 3-D position sensors 224 and 226 at a time of their choosing. For example, an application on the remote user device 260, wherein the remote user device 260 is communicably coupled to the controller 202, may prompt the user to turn their steering wheel to a “neutral position” of 180 degrees. Once the user turns the steering wheel to the neutral position, the mobile application then prompts the user to slowly move the vehicle 232 forward. Once the user moves the vehicle 232 forward, the mobile application indicates to the user that the calibration is complete when the mobile application has calculated the vehicle 232 is parallel to the trailer 230 (i.e., 180 degrees). In various embodiments, the GUI 262 on the remote user device 260 may have a graphical representation of the vehicle 232 and the trailer 230 as they align. Once aligned, the graphical representation shows the vehicle 232 and the trailer 230 linked together.

Vehicle and Trailer Profiles

Moreover, various embodiments of the present disclosure allow for a user profile on the remote client device 260, or the controller 202. The user profile will allow the user to input various physical dimensions of the trailer 230 and the vehicle 232 including, but not limited to a length of the vehicle, a width of the vehicle, a width of the trailer, a length of the trailer, a distance between a front axle and a rear axle of the vehicle, distance between a front axle and a rear axle of the trailer, and a distance between the vehicle 232 and the trailer 230. In various implementations, specific vehicle and trailer makes/models may be pre-programmed or loaded into the remote client device as well. Profiles may also be utilized during calibration or to further augment calibration.

Process for Guiding a Vehicle-Assisted Trailer

According to further aspects of the present disclosure, a computer implemented process 300 for guiding a vehicle-assisted trailer is disclosed. Unless otherwise stated, the components, definitions, and various embodiments previously disclosed in FIGS. 1-2 also apply herein. The process 300 herein refers to various calculations and methodologies. Examples of the various calculations and methodologies are disclosed in greater detail in the sections titled “Underlying Mechanics” and “Motion Control” at the end of this disclosure.

The process 300 comprises receiving at 302 output from a first 3-D position sensor that couples to a vehicle, by a controller, wherein the controller comprises a processor, a data transmission device, and a vehicle network bus reader.

The process 300 further comprises receiving at 304 output from a global positioning system and a second 3-D position sensor that couple to a trailer, by the controller, wherein the trailer is coupled to the vehicle. In various embodiments, the first and second 3-D position sensors comprise a magnetometer, an accelerometer, and a gyroscope (e.g., a nine-axis (i.e., 9-D) IMU).

By using the GPS information of the trailer and the 3-D position sensors placed independently on the vehicle and the trailer (i.e., instead of solely using a single 2-D bend angle senor), the absolute positions of the vehicle and the trailer can be assessed and tracked in real-time by calculating orientation differences between the 3-D position sensors.

The result of the calculation(s) is positional information of the vehicle and the trailer in true 3-D space. This 3-D “deterministic” approach provides a greater depth of detail with respect to the overall positions of the vehicle and the trailer when compared to the certain implementations of the 2-D “probabilistic” approach. Moreover, the capability to track a true 3-D position of the vehicle and the trailer in real-time potentially overcomes the issue of uneven or hilly terrain by accounting for elevation differences between the vehicle and the trailer.

In addition, utilization of two independent 3-D position sensors can improve signal/noise quality by eliminating common noise signals from ambient sources that affect both sensors.

In various embodiments, multiple controllers may be used. For example, there can be one or more controller(s) on the vehicle (e.g., a vehicle module(s)), and one or more controller(s) on the trailer (e.g., a trailer module(s)).

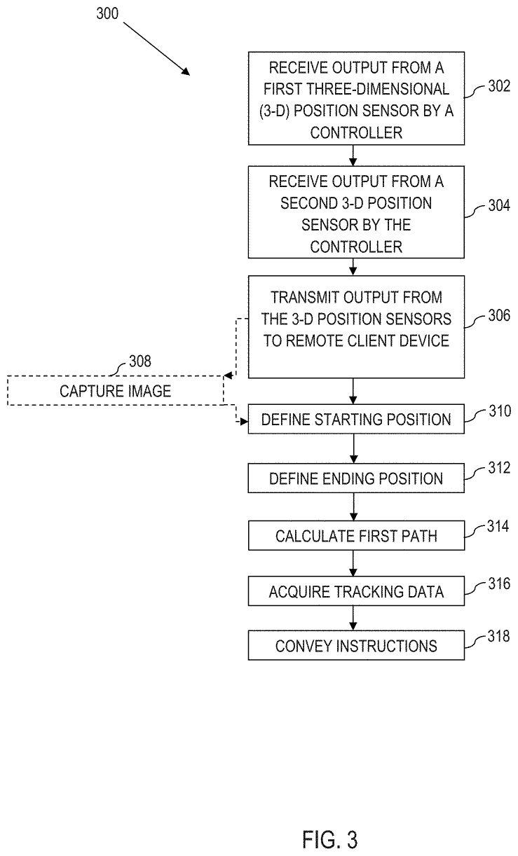

Still referring to FIG. 3, the process 300 comprises transmitting at 306 the output from the first 3-D position sensor and the second 3-D position sensor received by the controller, to a remote client device (as described above) via the data transmission device. In multiple embodiments, the remote client device has a graphical user interface (GUI).

In various embodiments, the process 300 further comprises capturing at 308 an image of the environment behind a trailer by using a first camera sensor. In such implementations, the first camera sensor is placed on the posterior side (facing outward) of the trailer that is coupled to the vehicle. In further embodiments, a second camera sensor can be utilized. The second camera sensor may also be placed on the posterior side of the trailer (thus allowing the camera sensors to have a ˜180-degree field of vision) or placed between the vehicle and the trailer. Any data or output produced by the camera sensors can be transmitted 306 to the remote client device via the controller (or by the camera sensor itself)

Yet further, the process 300 comprises defining at 310 a starting position and defining at 312 an ending position of the vehicle and the trailer. The starting position and the ending position can be defined on the GUI of the remote client device, which displays a map or an image of the area surrounding the vehicle and trailer, based on the GPS on the trailer, vehicle, or controller.

Any application or software capable of producing up-to-date maps, interactive maps, etc. such as GOOGLE EARTH™, GOOGLE MAPS™ (e.g., GOOGLE MAPS and GOOGLE EARTH are owned by Google, Inc., headquartered at 1600 Amphitheatre Parkway Mountain View, Calif. 94043), Galileo (i.e., the European navigation system), etc. A user of the remote client device may define the starting position and the ending position by selecting (e.g., “tapping”, placing a virtual pin, etc.) those positions directly on the map within the GUI.

Yet further, the process 300 comprises calculating at 314 a custom path that spans between the starting position and the ending position. The custom path may be calculated 314 by the processor on the controller, or by the remote client device. As noted previously, in some instances, the remote client device may have a more powerful processor than the controller (e.g., a smartphone). In such instances, the remote client device may be the preferred processing modality.

The custom path can be calculated 314 based off of the starting position and the ending position by using triangulation or other mathematical principals (e.g., the Lagrange method, refer to the “Underlying Mechanics” section for more in depth detail). Calculating 314 the custom path may incorporate many variables related to the vehicle and the trailer including spatial information between the 3-D position sensors, dimensions of the vehicle, dimensions of the trailer, gyro information from the trailer module, gyro information from the vehicle module, acceleration information from the trailer module, acceleration information from the vehicle module, steering angle information from the vehicle, etcetera.

In various embodiments, the user of the remote client device may alter or customize the custom path (e.g., draw a new path on the GUI of the remote client device, placing pins, placing pins and the system interpolates and smooths a path based on the pins, etc.).

Alternatively, the custom path that spans between the starting position and the ending position may be broken down into multiple segments, wherein each segment has its own starting and ending position (i.e., multiple calculations using the Lagrange method in a serial fashion).

In further embodiments, the custom path may be edited (i.e., modified), automatically, based on a captured image of a camera sensor(s). For example, the controller may alter or customize the custom path automatically based on an obstruction observed by the camera sensor(s) through image recognition, alert the user to the obstruction through the remote client interface, or a combination thereof. Additional sensors may be used for obstacle detection as well such as LIDAR or ultrasound.

The process 300 further comprises acquiring at 316 tracking data of the vehicle by utilizing the 3-D position sensor, the second 3-D position sensor, and the global positioning system as the vehicle and trailer traverse from the starting position to the ending position along the custom path. For example, the tracking data may be transmitted to the remote client device, which the remote client device uses to generate or convey steering instructions as described below.

Further, the process 300 comprises conveying at 318 steering instructions on the remote device, based on tracking data and the custom path, until the trailer arrives at the ending position.

In various embodiments, conveying 318 steering instructions on the remote device further comprises generating a graphical representation of the vehicle on the remote client device, which corresponds to the vehicle in real-time. In further implementations, conveying generating a graphical representation of the vehicle on the remote client device, which corresponds to the vehicle in real-time further comprises generating a graphical representation of a pair of front tires on the graphical representation of the vehicle, which corresponds to the vehicle in real time.

In embodiments that utilize one or more camera sensors. The process 300 further comprises capturing an image of the environment behind the trailer by using a camera sensor encoding the captured image using a camera signal encoder, transmitting the encoded image to the remote client device, and conveying steering instructions on to the remote device, based on tracking data and the encoded image of the environment, until the trailer arrives at the ending position.

### Practical Example 1

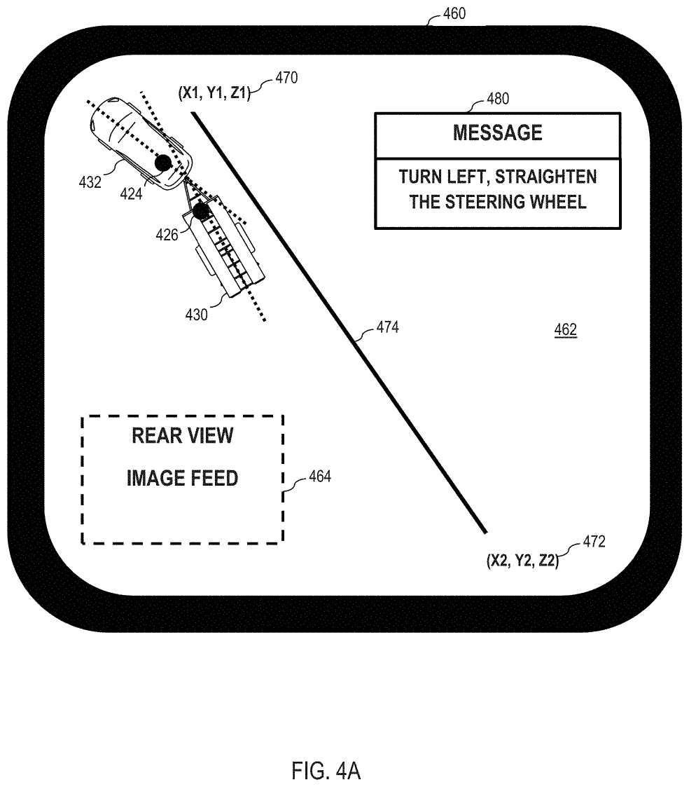

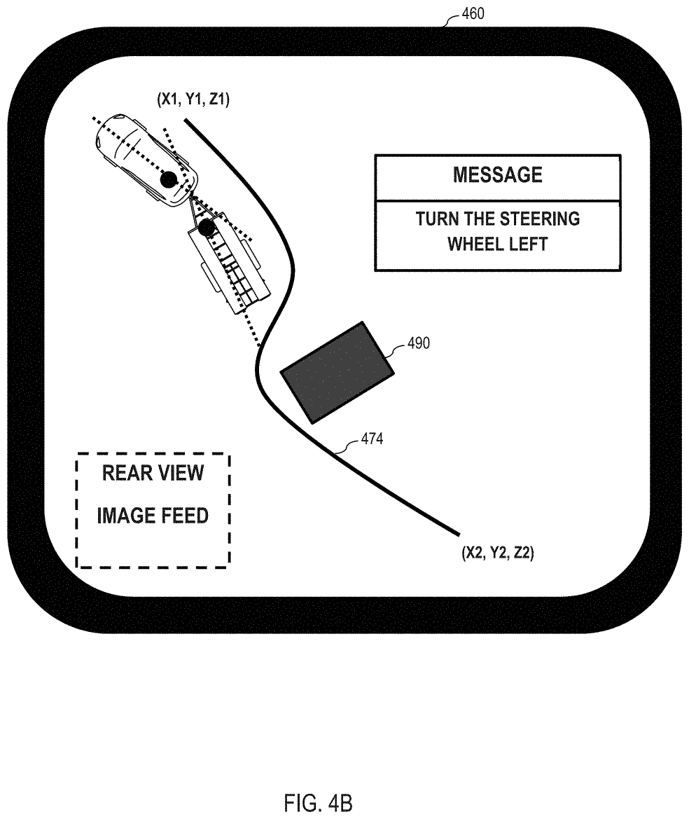

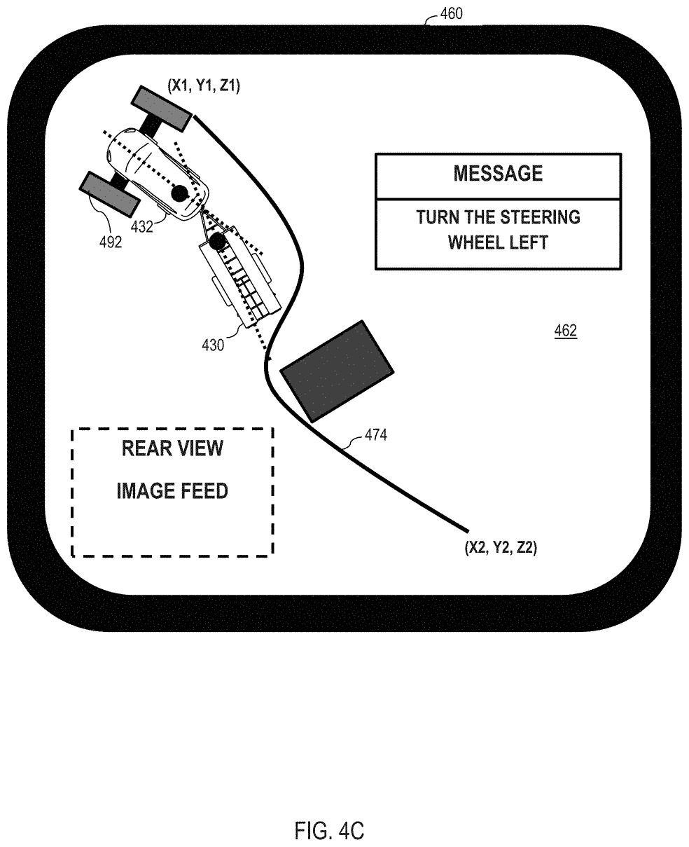

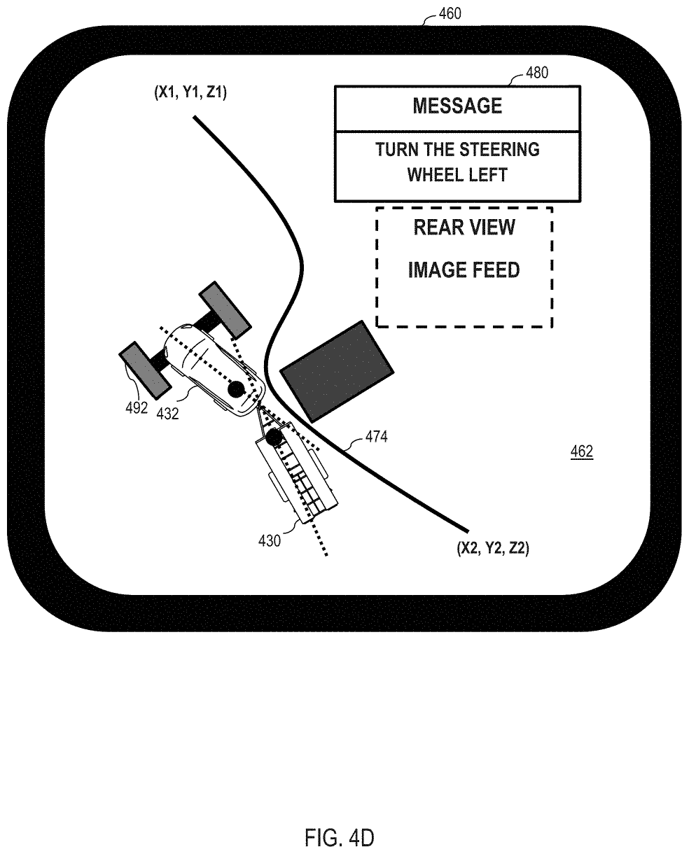

FIGS. 4A-D illustrate example embodiments of defining 310 the starting position, defining 312 the ending position, and calculating 314 the custom path. The numbered components of FIG. 4 (and its sub figures) match the numbered components of FIG. 1, including the definitions and embodiments thereof, except that the numbers in FIG. 4 are 300 higher. The various systems, processes, hardware, and embodiments disclosed in FIGS. 1-3 and can be combined in any combination of components described with reference thereto. In this regard, not every disclosed component need be incorporated.

In FIG. 4A, a remote client device 460 with a graphical user interface (GUI) GUI 462 is illustrated. A trailer 430 and a vehicle 432 are shown as graphical representations along with a corresponding first 3-D position sensor 424 and a second 3-D position sensor 426. The broken lines are example representations of position data (e.g., angular data), which are not required. In various embodiments, a secondary image 464 (e.g., a “picture in picture”) may also be displayed on the GUI 462. The secondary image 464 may be larger or smaller than the area shown in FIG. 4A. The secondary image 464 can display items such as a live feed of the space behind the trailer captured by a camera sensor, a real-time trajectory overlay, etcetera. For purposes of clarity and simplicity, the camera sensor(s), proximity sensors and other components are not shown.

Here, a starting position 470 and an ending position 472 are defined by a user of the remote client device 460. Once the starting position 470 and the ending position 472 are known, a custom path 474 that spans between the starting position 470 and the ending position 472 is calculated (e.g., by the remote client device 460) and optionally displayed on the GUI 462. Messages 480, such as steering instructions, can be displayed on the GUI 462 as needed to assist a driver of the vehicle 432 (e.g., the user of the remote client device). In various embodiments, messages 480 relating to a critical system event (e.g., loss of connection or hardware malfunction) may be displayed as well on the GUI 462.

FIG. 4B is analogous to FIG. 4A, except that an obstruction 490 is present. As a result, the custom path 474 is modified to avoid the obstruction 490. In various embodiments, the custom path 474 can be modified based on inputs of the user operating the remote client device 460 (e.g., the user manually drawing a new path with a finger). In further embodiments, the custom path 474 can be modified automatically by the system based an image data captured e.g., by camera sensor(s), live feed from Google Earth, etcetera. For instance, two camera sensors behind the trailer can detect potential obstructions or hazards, as well as measure an approximate distance until the ending position is reached. Further, any suitable mechanism for detecting obstacles 490 (e.g., proximity sensors) may be used.

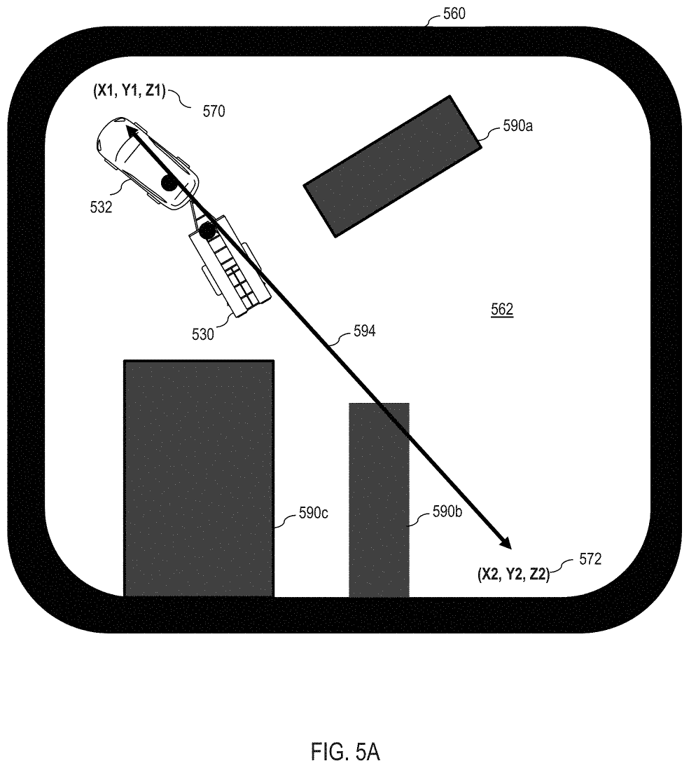

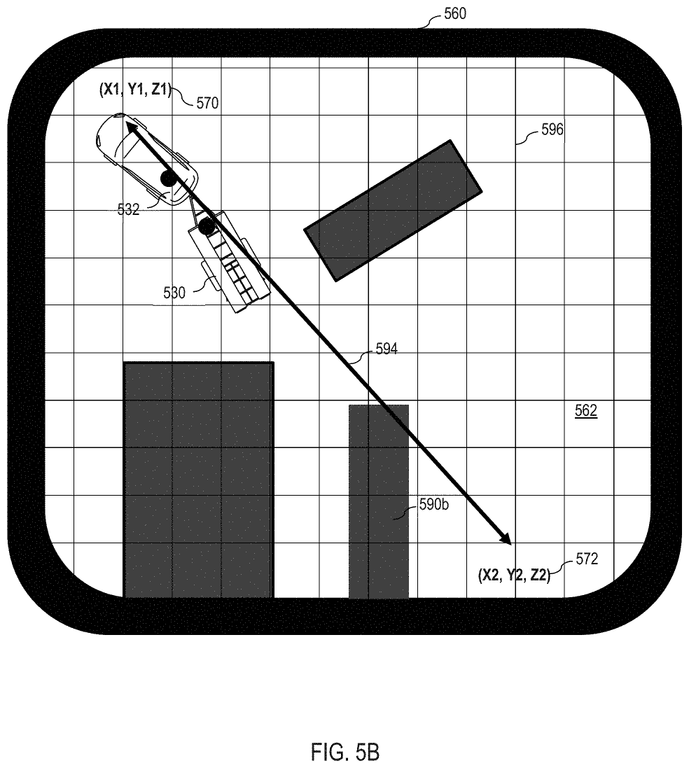

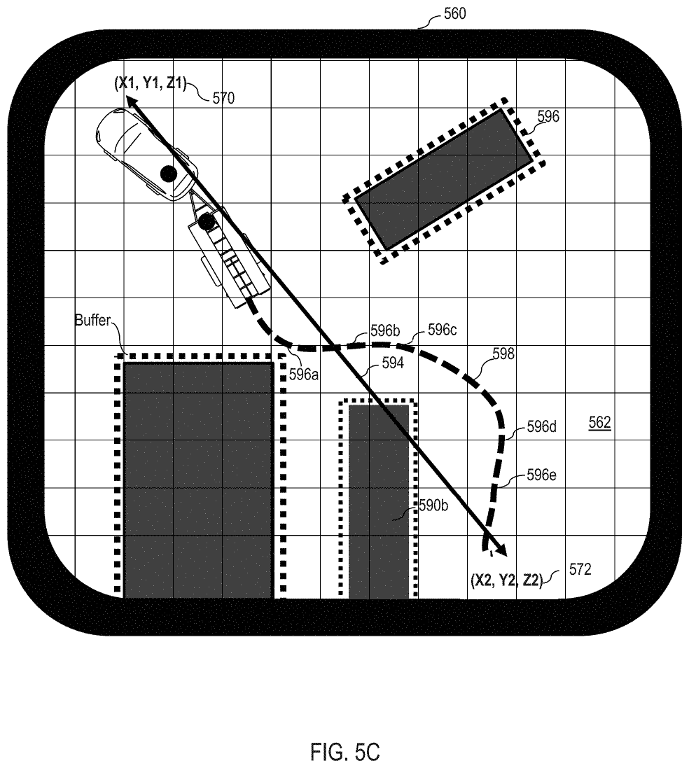

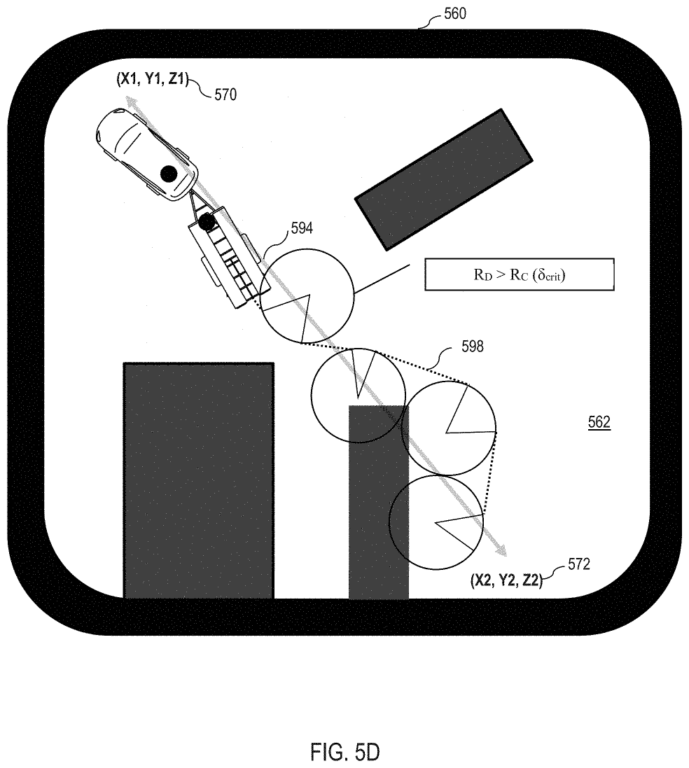

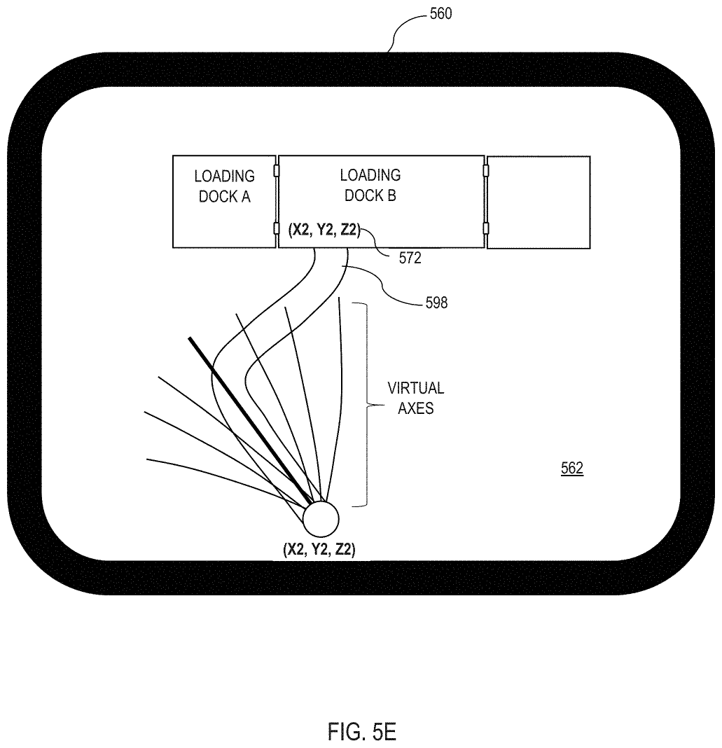

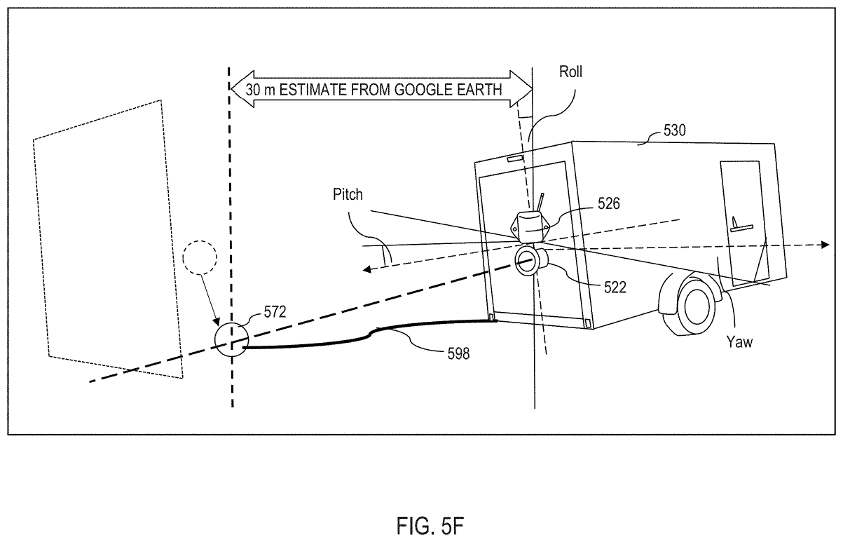

Moreover, various implementations allow the user operating the remote client device 460 to manually draw boundaries around obstructions (e.g., 490), buildings, or other objects. These boundaries can be applied as a separate layer or mask in the GUI 462. In various implementations, safety zones can be placed around the obstructions (e.g., buffer zones that surround forbidden areas) to account for potential errors in guidance or accuracy of positional data. Buffer zones are described in further detail in FIGS. 5A-F.

FIG. 4C, is an illustrative example of a graphical representation of a pair of front tires 492. As the vehicle 432 and the trailer 430 traverse the custom path 474, the vehicle 432 is monitored in real-time. Concurrently, the graphical representation of the pair of front tires 492, optionally including angle/orientation thereof, can be updated in real-time (e.g., through utilization of the vehicle network bus reader and controller), and displayed on the GUI 462 of remote client device 460.

FIG. 4D further illustrates the example embodiment in FIG. 4C. As the vehicle 432 and the trailer 430 traverse the custom path 474, the message 480 on the GUI 462 indicates that the driver needs to “turn the steering wheel left” in order to continue along the custom path 474. The graphical representation of the pair of front tires 492 may be provided to further assist the driver of the vehicle 432.

Not only can the driver of the vehicle 432 select the ending position 472 (e.g., on the remote client device 460), but the driver may also select an orientation or angle that the trailer 430 will be at the ending position 472. For example, the remote client device may have a virtual trailer that the driver can manipulate on the GUI 462 (e.g., two finger touch, “pinch”, select and orient, etc.).

Each embodiment disclosed herein, unless otherwise stated, may apply to other embodiments that are illustrated or disclosed herein (whether in whole or in part) (e.g., the graphical representation of the pair of front tires in FIG. 4D may also apply to FIG. 4A and/or FIG. 4B). For ease of clarity, FIG. 4A-4D illustrate the vehicle 432 and trailer 430 traveling alongside the custom path 474 (but is not limited to traveling alongside).

### Practical Example 2

Now referring to FIG. 5A, which is the first figure in a series that illustrates how various implementations of the present disclosure (e.g., the process 300) create and use a custom path. The numbered components of FIG. 5 (and its sub figures) match the numbered components of FIGS. 4A-D, including the definitions and embodiments thereof, except that the numbers in FIG. 5 are 100 higher. The various systems, processes, hardware, and embodiments disclosed in FIGS. 1-4D and can be combined in any combination of components described with reference thereto. In this regard, not every disclosed component need be incorporated.

Now referring to FIG. 5A, an overhead view of a vehicle 532 and a trailer 530 are shown on a GUI 562 within a remote client device 560. In this regard, the vehicle 532 and the trailer 530 can be graphical representations or a live representation thereof (e.g., via Google Earth), which is aided by the GPS and other vehicle metrics (e.g., orientation such as pitch/roll/yaw) read by the vehicle network bus reader, the controller, and the 3-D position sensors for location accuracy.

A user of the remote client device 560 selects a starting position 570 (X1, Y1, Z1) and an ending position 572 (X2, Y2, Z2). In addition to selecting the ending position 572, the user may also select an ending orientation (i.e., what the orientation of the trailer 530 will be in when the trailer 530 reaches the ending position 572). Based on the selection, a shortest path line 594 that spans between the starting position 570 and the ending position 572 is calculated. While the shortest path line 594 (i.e., a least effort gradient field) is shown in FIG. 5A, showing the shortest path line 594 on the GUI 562 is not required. The shortest path line 594 ignores any obstacles 590 (e.g., 590 a, b, and c) that may intersect with shortest path, which in this case is 590b. Generally, obstacles 590 can be detected on google maps, via the camera sensor, light detection and ranging (LIDAR), ultrasound, or any similar mechanism.

Continuing to FIG. 5B, a path grid 596 overlays the GUI 562. Each point of the path grid 596 can have its own values such as position, tangent, curative, GPS coordinate, 3-tupel, etcetera. In this example, the shortest path line 594 intersects with the obstacle 590b. Therefore, the shortest path line 594 is not a suitable pathway between the starting point 570 and the ending point 572 for the vehicle 532 and trailer 530 to travel.

As a result, a custom path is calculated as shown in FIG. 5C. The custom path 598 is different from the custom path of FIGS. 4A-D (see reference number 474, FIGS. 4A-D). Calculation of the custom path 598 can be accomplished using Dijkstra's algorithm, or any other suitable method. Generally, the custom path 598 intersects with various path grid 596 points that do not intersect with any obstacles 590 (or other forbidden areas).

In this example, the custom path 598 intersects with path grid points 596a, 596b, 596c, 596d, and 596e. In various embodiments, when calculating the custom path 598, the user (or the system) can specify that the custom path 598 is at least one grid point from the nearest obstacle 590, thereby creating a buffer or envelope (shown as dashed boxes around the obstacles 590) for the custom path 598. The buffer can be multiples of grid spacing or a fraction of minimum turn radius.

The custom path can also be calculated using Dubins Path Method, which typically refers to a combination of any number of straight lines and any number of arcs segments with equal radius such that the shortest curve that connects two points in the two-dimensional Euclidean plane (i.e., x-y plane) with a constraint on the curvature of the path. Ideally, the smallest possible turning radius, r>R_{C}(δcrit), is used.

FIG. 5D illustrates a visual representation of the Dubins Path Method using circle geometry to smooth and refine the custom path 598. Cone shapes within the circles illustrate curvature of the circles that the custom path 598 follows. In FIG. 5D, the path grid 596 has been removed and the shortest path line 594 has been made semi-transparent for clarity purposes. Implementing the Dubins Path Method in this manner reduces the chance that the vehicle and trailer will jackknife by utilizing a small turning radius (or in some cases the smallest turn radius possible).

For example, FIG. 5E illustrates a rear-view of the vehicle-trailer system on the GUI 562 of the remote client device 560 (e.g., via the camera sensor(s)), wherein the vehicle-trailer system is moving along the custom path. In FIG. 5E, the driver of the vehicle is traveling to the ending position 572 along the custom path 598 to “Loading Dock B”.

Further, the system monitors the driver's trajectory, compares the driver's trajectory against the custom path 598, and issues steering corrections as needed via the GUI 562 on the remote client device 560. The steering corrections may be further augmented by virtual axes that correspond to the orientation of the trailer (or the vehicle, or a combination thereof). Ideally, the driver of the vehicle centers the virtual axes on the custom path 598 as shown in FIG. 5E. The thicker weighted line represents a center of the virtual axes. Alternatively, color schemes may be used.

As disclosed above, the custom path 598 can be modified by the user of the remote client device 560 (e.g., click and drag, touch screen, etc.), which in the case of FIG. 5E may be changing the ending position 572 from “Loading Dock B” to “Loading Dock A”. If the custom path is modified, a new distance is calculated. The new distance (D+d) is calculated based on the formula: sin(α)=Δh/d (α is the pitch angle sensed by the 9D sensor) (i.e., D=d+Δh/sin(α)). Yaw (β) may also be re-calculated by Δβ for direction relative to the trailer rear front. In multiple embodiments, it is possible to make multiple adjustments, or modify “as you go”.

FIG. 5F is a visual illustration of equipment on the trailer 530 using positional information to adapt to a change of the ending point 572 (vehicle not shown for simplicity). In a practical example, a user changes the ending point 572 to a new position (e.g., via the graphic user interface 562 in FIG. 5E) as illustrated by the dashed-out circle and arrow leading to reference number 572. Based on the changed ending point, positional data (i.e., pitch, roll, and yaw as denoted in FIG. 5F) acquired by the 3-D/9-D position sensor 526 and visual data acquired by the camera 522 can perform recalculations (e.g., D=d+Δh/sin(a)) for the custom path 598.

Autonomous Features

Systems and processes herein may allow for fully autonomous operation of the vehicle-assisted trailer process. The applicable sensors (e.g., camera, GPS, 3-D position sensors, etc.) may already in place on select vehicles. Further, the vehicle network bus reader has access to the CAN bus of the vehicle. The steering motions of the driver may be replaced by the vehicle's power steering device via the CAN bus communication. As a result, under various implementations of the present invention, it may be possible to guide a vehicle-assisted trailer (and in particular a semi-trailer truck) autonomously.

While aspects of the present disclosure relate to systems and processes relating to guidance of vehicle-assisted trailers, it can possible to apply various aspects of the present disclosure to a vehicle by itself.

Stand-Alone Vehicle Guidance

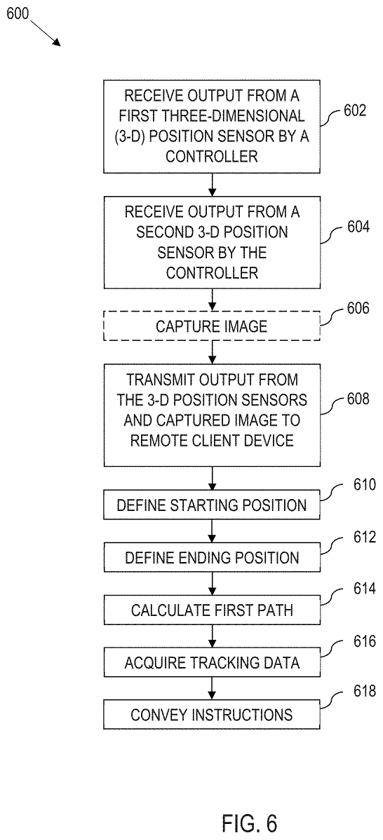

Now referring to FIG. 6, a computer implemented process 600 for guiding a vehicle is disclosed. Unless otherwise stated, the components, definitions, processes, and various embodiments previously disclosed in FIGS. 1-5 also apply herein where applicable. In this regard, not every disclosed component need be incorporated.

The process 600 comprises receiving at 602 output from a first 3-D position sensor that couples to a front end of a vehicle, by a controller, wherein the controller comprises a processor, a global positioning system, a data transmission device, a vehicle network bus reader, and a camera signal encoder. As noted above, the first 3-D position sensor may stand alone or be incorporated into the controller. In various embodiments, the controller further comprises a motion module.

The process 600 further comprises receiving at 604 output from a second 3-D position sensor that couples to a rear end of the vehicle, by the controller. One distinction from the process 300 and the process 600 is that the second 3-D position sensor couples to the vehicle instead of an attached trailer.

Yet further, the process 600 comprises capturing at 606 an image of the environment behind the vehicle by using a first camera sensor. In various embodiments, a second camera sensor may be included for a front of the vehicle front and in the configurations disclosed above.

Additionally, the process 600 comprises transmitting at 608 the captured image of the environment behind the vehicle through the camera signal encoder, the output from the first 3-D position sensor, and the second 3-D position sensor to a remote client device. In some embodiments of the process where two 3-D position sensors are used, a differential between the two sensors may be used as the data to help remove any noise that may be present in the environment. The differential may be calculated on the client device.

Moreover, the process 600 comprises defining at 610 a starting position and at 612 an ending position of the vehicle and calculating 614 a custom path that spans between the starting position and the ending position (e.g., by a processor on the remote client device).

Further, the process 600 comprises acquiring at 616 tracking data of the vehicle by utilizing the first 3-D position sensor, the second 3-D position sensor, and the global positioning system as the vehicle traverses from the starting position to the ending position along the custom path.

Yet further, the process 600 comprises conveying at 618 steering instructions on to the remote device, based on tracking data and the custom path, until the vehicle arrives at the ending position.

In various embodiments, the vehicle is autonomously driven from the starting position to the ending position along the custom path through commands issued by the remote client device and the controller.

Example Hardware Layout for the Process 600

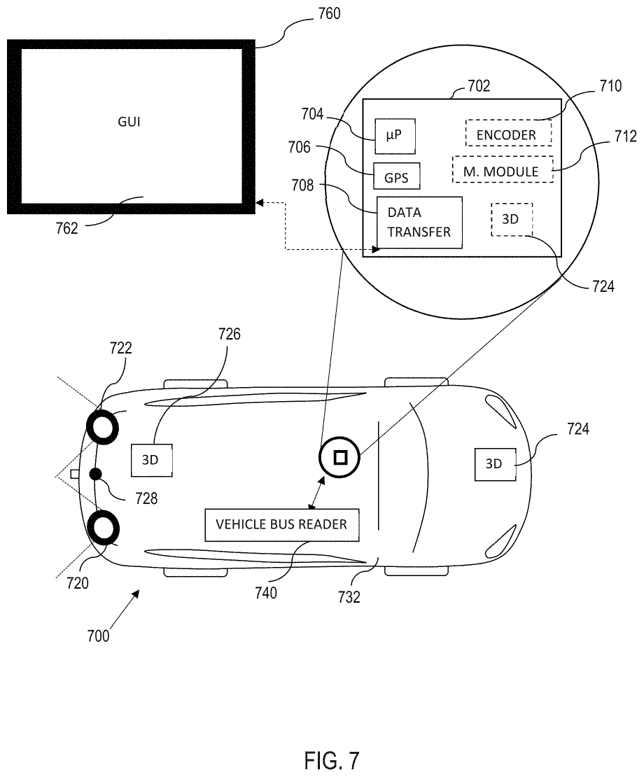

Referring to the figures, FIG. 7 illustrates an example embodiment of a hardware layout 700 for a vehicle utilized in the process 700. Unless otherwise stated, the components, definitions, processes, and various embodiments previously disclosed in FIGS. 1-6 also apply herein where applicable. In this regard, not every disclosed component need be incorporated. The numbered components of FIG. 7 match the numbered components of FIG. 2, including the definitions and embodiments thereof, except that the numbers in FIG. 7 are 500 higher.

In FIG. 7, a controller 702 is installed on the vehicle 732, the controller 702 comprises a processor 704, a GPS 706, a data transmission device 708, and a camera signal encoder 710. The controller 702 communicably couples with a vehicle network bus reader 740 as well as the remote client device 760, wherein the remote client device 760 has a GUI 762. In various embodiments, the controller 702 further comprises a motion module 712.

Moreover, a first camera sensor 720 and a second camera sensor 722 are placed on the vehicle 732 in various configurations (an example field of view for each camera sensor is illustrated by, but not limited to, the dashed lines). In various embodiments, a proximity sensor 728 may be incorporated.

Further, a first 3-D position sensor 724 and a second 3-D position sensor 726 are placed on the vehicle 732. By using the 3-D position sensors 720 and 722 placed on opposing ends of the vehicle 732, the processor 704 on the controller 702 can identify spatial positions and accelerations of the opposing ends vehicle 732 by calculating differences between the 3-D position sensors 724 and 726. In various embodiments, the first 3-D position sensor 724 may be coupled to the controller 702 directly (as shown dashed lines), as opposed to being coupled to the vehicle 732.

System for Guiding a Vehicle-Assisted Trailer

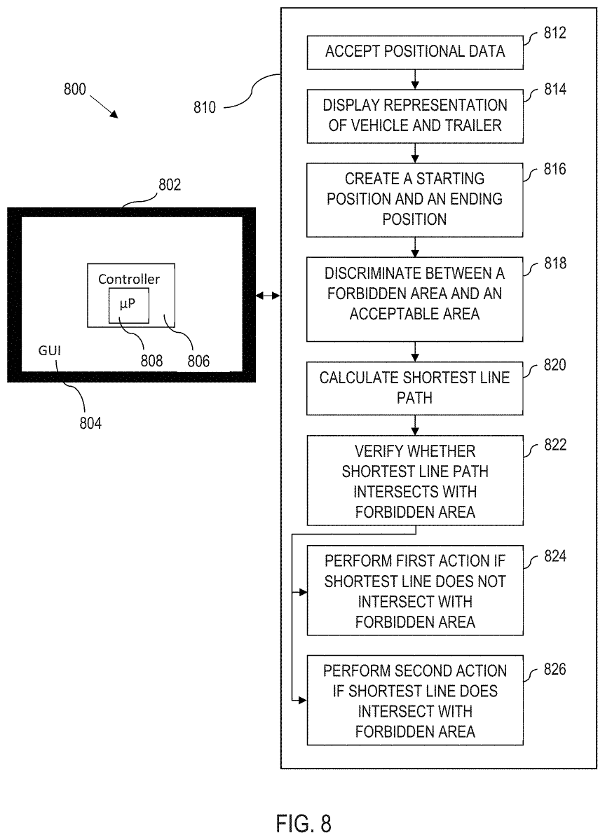

Referring to the figures, FIG. 8 illustrates an example embodiment of a system 800 for guiding a vehicle-assisted trailer. Unless otherwise stated, the components, definitions, processes, and various embodiments previously disclosed in FIGS. 1-7 also apply herein where applicable. In this regard, not every disclosed component need be incorporated.

The system 800 comprises a remote client device 802 having a graphical user interface (GUI) 804, a controller 806, and a processor 808 coupled to memory 810. A program within the memory 810 instructs the processor 808 to perform accepting 812 positional data (e.g., GPS information or positional data from 9-D positional sensors) from a vehicle and a trailer.

Further, the memory 810 instructs the processor 808 to perform displaying 814, on the GUI, a representation of the vehicle and the trailer within an environment based on the positional data (see e.g., reference number 532 in FIG. 5). Further, a user of the system 800 may also modify an orientation of the trailer and/or vehicle directly in the GUI 804.

Moreover, the memory 810 instructs the processor 808 to perform creating 816 a starting position and an ending position on the GUI based on inputs from a user of the remote client device (see e.g., reference numbers 570 and 572 in FIG. 5).

Also, the memory 810 instructs the processor 808 to perform discriminating 818 between a forbidden area and an acceptable area within the environment. For example, the system may determine that certain structures or obstacles (see e.g., reference number 590 in FIG. 5) represent a forbidden area. Alternatively, the user of the system 800 could manually select forbidden areas (e.g., draw a boundary around the forbidden areas, or “paint” the forbidden areas on the GUI 804).

Further, the memory 810 instructs the processor 808 to perform calculating 820 a shortest line path between the starting position and the ending position (see e.g., reference numbers 570, 572, and 594 in FIG. 5), and verifying 820 whether the shortest line path intersects with the forbidden area.

Yet further, the memory 810 instructs the processor 808 to perform verifying 822 whether the shortest line path intersects with the forbidden area.

Moreover, the memory 810 instructs the processor 808 to perform, performing a first action 824 if the shortest line path does not intersect with the forbidden area, the first action comprising conveying steering instructions on the GUI, based on the positional data, as the vehicle and trailer traverse from the starting position to the ending position along the shortest line path.

Also, the memory 810 instructs the processor 808 to perform, performing a second action 826 if the shortest line path intersects with the forbidden area, the second action comprising superimposing an overlay grid on the representation of the vehicle and the trailer within the environment, wherein each grid point within the overlay grid is associated with a position in the environment. The section action 826 further comprises excluding grid points that are within the forbidden area, modifying the shortest line path to correspond with grid points within the acceptable area within the environment, thus creating a custom path, and conveying steering instructions on the GUI, based on the positional data, as the vehicle and trailer traverse from the starting position to the ending position along the custom path (see e.g., FIGS. 5C-5D).

In various implementations, the system 800 may be implemented on an autonomous vehicle. In such implementations, the system 800 executes the steering instructions as the autonomous vehicle and trailer traverse from the starting position to the ending position along the custom path (as opposed to merely conveying the steering instructions).

Underlying Mechanics

The following figures and disclosure are directed toward the underlying mechanics (e.g., algorithms, process flows, etc.) that contribute to aspects of the present disclosure as disclosed above.

Many of the implementations and embodiments herein utilize Lagrangian mechanics and equations to determine a position of the vehicle and associated trailer. Lagrangian mechanics enable the various aspects of the present disclosure to concentrate on only the non-constraint forces and exclude all “constraint forces” as a result of the “mechanical linkage” in the equations of motion. Mathematically, this is accomplished by transforming each position vector (rₖ) to a common reduced set of independent, “generalized” coordinates (q): rₖ (q, t)=(xₖ (q,t), yₖ (q,t), zₖ (q,t),t).

Modeling the dynamics of a vehicle-trailer system with the Lagrange plus Constraints formalism in a Cartesian coordinate system requires only four independent state variables since the vehicle and trailer is rigidly coupled and the wheels do not allow perpendicular movements (>constraints). Two variables for orientation of the vehicle relative to the x-axis are Θ1(car) and Θ2(trailer), and two variables for the position of the trailer. These can be the coordinates of any reference point on the trailer assembly. For instance, the trailer's wheel axle center (xC, yC) may be used. Mathematically, a hitch angle (δ) may be resolved via: δ=Θ1−Θ2.

The operator or driver of the vehicle-trailer system has two control inputs, which are a velocity (v) of the vehicle, and a steering angle (Φ) of the vehicle. Thus, a kinematic model is given by four equations:

(x′)c=v cos(Θ1−Θ2)cos(Θ2)

(y′)c=v cos(Θ1−Θ2)sin(Θ2)

(Θ′)=v tan(Φ)/L₁

(Θ′)=v sin(Θ1−Θ2)/L₂

From these equations, a relationship can be established between the hitch angle change speed (dδ/dt=angular velocity of hitch angle δ) as a function of the steering angle Φ: (δ′)=((Θ1′)−(Θ2′))=(v tan (Φ)/L₁)−(v sin (δ)/L₂).

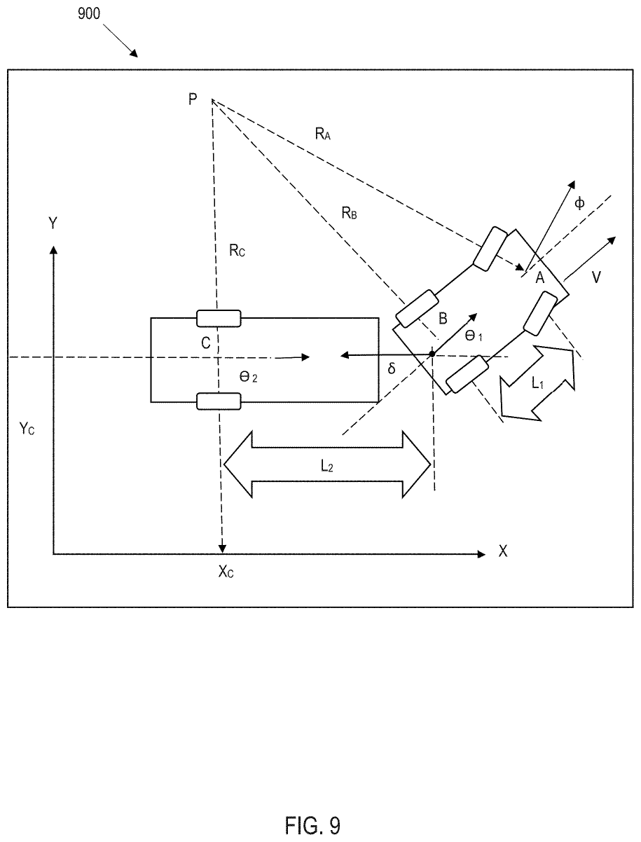

Now referring to FIG. 9, which illustrates an angular model 900 illustrating a circulating state, the vehicle-trailer system has two equilibrium points with regard to S. One is stable, wherein δ=π(>not possible due to geometry). The other is unstable, wherein dδ/dt=0 (a “Circulating State”; point C moves on a circle around P shown in FIG. 9).

For the circulating state where δ=constant dδ/dt=0. Equation (2) allows calculating a related steering angle Φ_{circ} for keeping the trailer axle on an exact circle: Φ_{circ}=tan⁻¹ (L₁ sin (δ)/L₂).

As a result, increasing the steering angle Φ in this situation results in a decreasing hitch angle and decreasing it results in the opposite. The number of control variables is less than the number of state variables, which means the system is non-holonomic (i.e., not all movements are allowed, like moving the trailer sideways). If Φ_{circ} is equal to the maximum (largest) steering angle, the operator can no longer straighten out the vehicle-trailer system in reverse motion but only with a forward motion.

In some instances, the vehicle-trailer system may jackknife at a hitch angle δ_{crit}: δ_{crit}=sin⁻¹ (L₂/R_{B})=sin⁻¹ (L₂ tan (Φmax/L₁). A critical angle can be calculated based on the trailer-to-car length ratio and the maximum steering angle. Jackknife can be avoided by simply limiting the maximum hitch angle to δₘₐₓ<δ_{crit}.

In various implementations, it is possible to estimate an indirect steering angle via the 9-D sensor by deducting the steering angle from the change of Θ1 over sampling time Ts: w(t)=(Θ(t)−Θ(t−Tₛ)/Tₛ. Such an equation leads to a simplified equation for the steering angle: Φ(t)=tan⁻¹ (L₁ (w(t)/(v)(t)). further, w(t) may be directly derived from the vehicle module 9D sensor as well.

The hitch angle change speed dδ/dt now becomes: (δ′)=((Θ1′)−(Θ2′))=(v tan (Φ)/L₁) ((Δ/L₂)cos (δ)+1)−v sin (δ)/L₂. An off-axle dδ/dt error compared to an on-axle hitch point at reverse speed of 2 m/s, 3 m car wheelbase, 5 m trailer axle-to-hitch length, 0.5 m hitch offset on the car is 10% for a hitch angle of δ=0° and it decreases with increasing hitch angle δ and trailer length, which can be considered if more precision is required for calculation of Φ_{circ}.

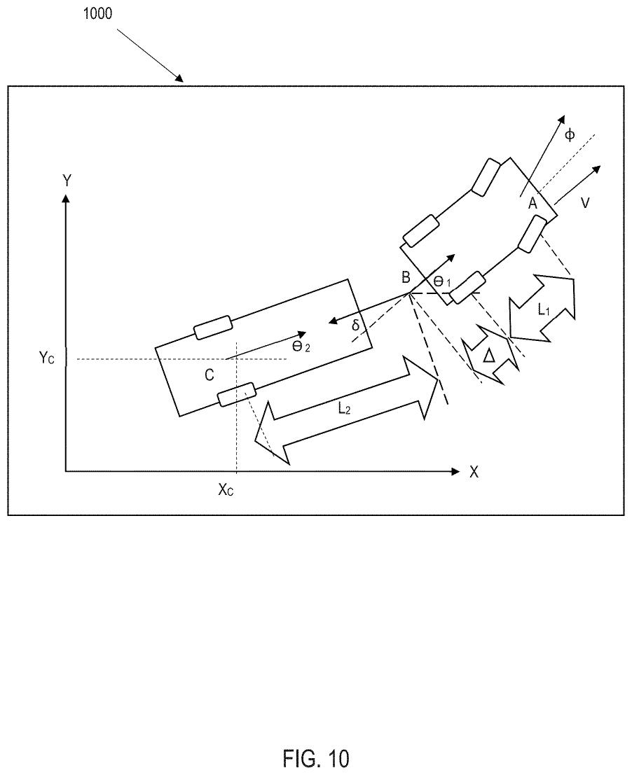

As shown in FIG. 10, which illustrates a kinematic model for off-angle hitching, a relationship between steering angle and hitch angle can be defined for circular motion: Φ_{circ}=tan⁻¹ ((L₁ sin(δ)/L₂)/((Δ/L₂)cos (δ)+1)). The critical steering angle Φ_{circ} for the off-axle hitch point is about 10% for a hitch angle of δ=0° and it decreases with increasing hitch angle δ and trailer length. It can be considered if more precision is required for calculation of Φ_{circ}.

Motion Control

Generally, one motion control objective is to keep the trailer axle center on the custom path. Accordingly, many of the prompts, instructions, and other navigational features are related to that motion control objective.

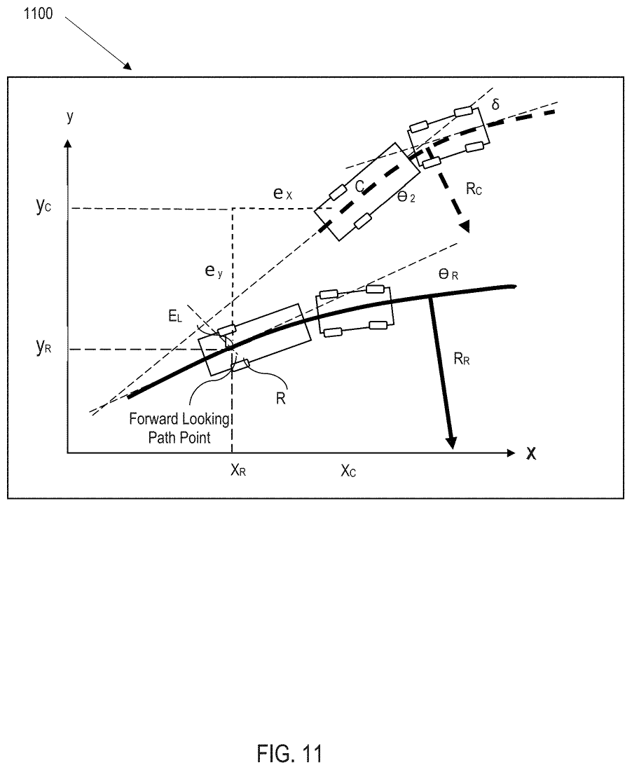

Now referring to FIG. 11, which illustrates an angular model for a trailer on path stabilization utilizing a forward-looking path. While forward travel motion of a vehicle-trailer system is generally stable, this is not necessarily the case for the reverse travel motion. Accordingly, motion controls for reverse travel motion should be approached differently.

For example, approaches for reverse travel motion may need to take into account for differences in the type of vehicle-trailer used (on-axle or off-axle hitched). One motion control approach will be based on a two-layer control loop; an outer control loop stabilizes the system to the path and an inner control loop stabilizes the hitch angle. The outer and inner control loops may also be referred to as the path stabilization controller and the hitch angle controller, respectively.

With respect to the outer loop, convergence of the car-trailer system to the path utilizes three error measurements.

The first error measurement is for lateral errors: E_{L}=e_{y} cos Θ₂−eₓ sin Θ₂.

The second error measurement is for orientation errors: E_{Θ}=Θ_{R}−Θ₂.

The third error measurement is for curvature errors: E_{C}=(1/R_{R})−(1/R_{C})

The three error measurements are used to decide the hitch angle δ_{ref} of the vehicle-trailer system requires to follow the path and the linear control law applies: δ_{ref}=(K_{L}×E_{L})+(K_{Θ}×E_{Θ})+(K_{C}×E_{C}), wherein (K_{L}, K_{Θ}, K_{C} are tuning parameters) and objective: δ_{ref}=0!. Thus, the above can be used to calculate a forward-looking path point. The forward-looking path point may be conceptualized as a temporary target point that the vehicle and trailer are moving toward. Once the vehicle and trailer have reached the forward-looking path point, a new forward-looking path point is calculated.

Alternatively, the forward-looking path point may be conceptualized as a “sliding point” that stays a fixed distance from the vehicle and trailer (e.g., two-times the trailer length). In either instance, the hitch angle δ_{ref} is monitored to ensure that a jackknife will not occur. If a jackknife is imminent, then corrections can be made.

With respect to the inner loop, the hitch angle control via car steering angle is accomplished via standard proportional integral (PI) control: Φ=K_{P} (−δ_{ref}−δ)+K_{I} (∫ t, 0) (−δ_{ref}−δ)dt, wherein K_{P} and K_{I} are tuning parameters and δ_{ref} is the hitch angle required to follow the path. The time dependency of δ and δ_{ref} is not considered for simplicity.

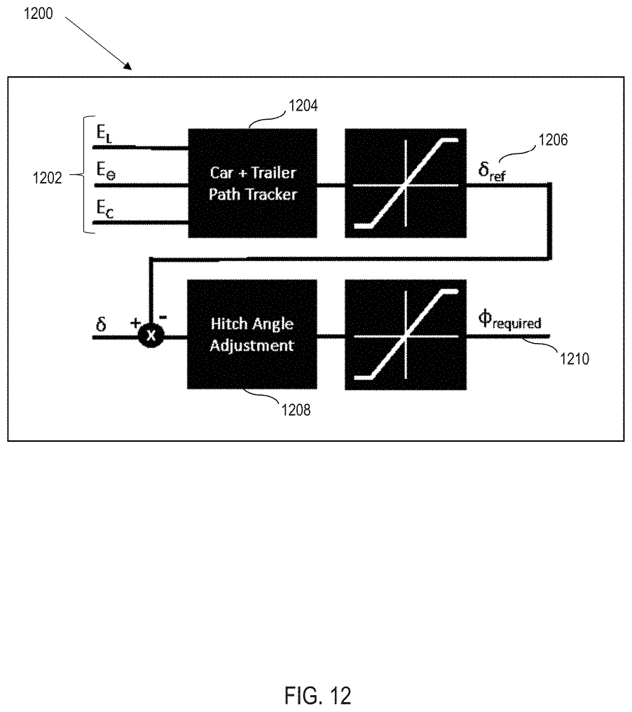

FIG. 12, which is a motion control block diagram 1200 with respect to hitch angle adjustments, illustrates a simplified visual for hitch angle adjustments and path stabilization. As noted above, E_{L}, E_{Θ}, and E_{C} (the “path alignment errors”) 1202 are applied to the car/vehicle and trailer 1204 to determine the hitch angle δ_{ref} 1206, which is used to determine the hitch adjustment angle 1208 necessary to derive the required steering angle Φ required 1210.

Miscellaneous

Maximum Steering Angle is derived from a combination of L₁, L₂, δ_{crit}, and trailer parking test drives.

Reference Point Calculation (look-ahead): 2 sec.×speed+L₂ with reference to trailer axle center projected path.

Tuning of parameters is accomplished as a combination of L₁, L₂, δ_{crit}, and trailer parking test drives.

As will be appreciated by one skilled in the art, aspects of the present disclosure may be embodied as a system, method or computer program product. Moreover, some aspects of the present disclosure may be implemented in hardware, in software (including firmware, resident software, micro-code, etc.), or by combining software and hardware aspects. Furthermore, aspects of the present disclosure may take the form of a computer program product embodied in one or more computer readable storage medium(s) having computer readable program code embodied thereon.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Aspects of the disclosure were chosen and described in order to best explain the principles of the disclosure and the practical application, and to enable others of ordinary skill in the art to understand the disclosure for various embodiments with various modifications as are suited to the particular use contemplated.

What is claimed is:

1. A computer implemented process for guiding a vehicle assisted trailer, the process comprising:
receiving output from a first three-dimensional position sensor that couples to a vehicle, by a controller, wherein the controller comprises a processor, a data transmission device, and a vehicle network bus reader;
receiving output from a second three-dimensional position sensor and global positioning system that couple to a trailer, by the controller, wherein the trailer is coupled to the vehicle;
transmitting the output from the global positioning system, the first three-dimensional position sensor and the second three-dimensional position sensor received by the controller to a remote client device;
defining a starting position of the vehicle and the trailer in a map image;
defining an ending position of the vehicle and the trailer in the map image;
calculating a custom path that spans between the starting position and the ending position in the map image;
acquiring tracking data of the vehicle by utilizing the first three-dimensional position sensor, the second three-dimensional position sensor, and the global positioning system as the vehicle and trailer transition from the starting position to the ending position along the custom path; and
conveying steering instructions to the remote device, based on the tracking data and the custom path, until the trailer arrives at the ending position.

2. The computer implemented process of claim 1, further comprising:
capturing an image of the environment behind the trailer by using a camera sensor;
encoding the captured image using a camera signal encoder;
transmitting the encoded image to the remote client device; and
conveying steering instructions on to the remote device, based on the tracking data and the captured image of the environment, until the trailer arrives at the ending position.

3. The computer implemented process of claim 1, wherein calculating a custom path that spans between the starting position and the ending position comprises modifying the custom path based on inputs of a user operating the remote client device.

4. The computer implemented process of claim 1, wherein calculating a custom path that spans between the starting position and the ending position comprises editing, automatically, the custom path based on the captured image by the camera sensor.

5. The computer implemented process of claim 1, wherein conveying steering instructions on to the remote device, based on the tracking data and the custom path, until the trailer arrives at the ending position comprises generating a graphical representation of the vehicle on the remote client device, which corresponds to the vehicle in real-time.

6. The computer implemented process of any of claim 5, wherein generating a graphical representation of the vehicle on the remote client device, which corresponds to the vehicle in real-time further comprises generating a graphical representation of a pair of front tires on the graphical representation of the vehicle, which correspond to the vehicle in real-time.

7. The computer implemented process of claim 1, wherein conveying steering instructions based on tracking data on the remote device, until the trailer arrives to the ending point comprises steering the vehicle autonomously by implementing the steering instructions on the vehicle using the controller and applicable vehicle systems.

8. A trailer park-assist system, the system comprising:
a controller comprising:
a processor; and
a data transmission device that receives data sent to the controller and transmits data sent by the controller, wherein the data received by the controller includes a geographic location from an associated global positioning system;
a first three-dimensional position sensor that communicably couples to the controller, which measures changes in spatial position on three axes with reference to the geographic location, wherein when installed, the first three-dimensional position sensor couples to a vehicle;
a second three-dimensional position sensor that communicably couples to the controller, which measures changes in spatial position on three axes with reference to the geographic location, wherein when installed, the second three-dimensional position sensor couples to a trailer;
a vehicle network bus reader that communicably couples to the controller and a vehicle network bus of the vehicle, wherein when installed, the vehicle network bus reader communicates vehicle information from the vehicle network bus to the controller; and
wherein the controller is capable of communicably coupling to a remote client device, the remote client device configured to convey steering instructions.

9. The trailer park-assist system of claim 8, wherein the controller communicably couples to a remote client device, the controller further configured to:
capture image data of a first area of interest by a first camera sensor that communicably couples to the controller, which captures and transmits the image data of the first area of interest to the controller, wherein when installed, the first camera sensor couples onto a posterior side of the trailer;
transmit the image data of the first area of interest from the controller to the remote client device via the data transmission device;
transmit steering instructions to the remote client device based on the vehicle information communicated by the vehicle bus network reader, the image data of the first area of interest, and the geographical position tracked by the associated global positioning system; and
receive user inputs from the remote client device.

10. The trailer park-assist system of claim 8, wherein:
the remote client device comprises a graphical user interface.

11. The trailer park-assist system of any of claim 8, wherein:
the remote client device further comprises a user profile that is configured to accept data input relating to physical dimensions of at least one of a length of the vehicle, a width of the vehicle, a width of the trailer, a length of the trailer, a distance between a front axle and a rear axle of the vehicle, distance between a front axle and a rear axle of the trailer, and a distance between the vehicle and the trailer.

12. The trailer park-assist system of claim 8, wherein the controller communicably couples to a remote client device, the controller further configured to:
capture image data of a second area of interest by a second camera sensor that communicably couples to the controller, which captures and transmits the image data of the second area of interest to the controller, wherein when installed, the second camera sensor couples onto the posterior side of the trailer or between the vehicle and the trailer.

13. The trailer park-assist system of any of claim 12, wherein:
the first camera sensor comprises an infrared camera sensor.

14. The trailer park-assist system of any of claim 13, wherein:
the second camera sensor comprises an infrared camera sensor.

15. The trailer park-assist system of any of claim 8, wherein:
the first three-dimensional position sensor and the second three-dimensional position sensor each comprise a magnetometer, a gyroscope, and an accelerometer.

16. The trailer park-assist system of any of claim 8, further comprising:
a proximity sensor that communicably couples to the controller, which captures and transmits environmental spatial data to the controller, wherein when installed, the proximity sensor couples onto the posterior side of the trailer.

17. A computer implemented process for guiding a vehicle, the process comprising:
receiving output from a first three-dimensional position sensor that couples to a front end of a vehicle, by a controller, wherein the controller comprises a processor, a global positioning system, a data transmission device, a vehicle network bus reader, and a camera signal encoder;
receiving output from a second three-dimensional position sensor that couples to a rear end of the vehicle, by the controller;
capturing an image of the environment behind the vehicle by using a first camera sensor;
transmitting the captured image of the environment behind the vehicle through the camera signal encoder, the output from the first three-dimensional position sensor, and the second three-dimensional position sensor to the remote client device;
defining a starting position and an ending position of the vehicle in a map image displayed on the remote client device;
calculating a custom path that spans between the starting position and the ending position in the map image;
acquiring tracking data of the vehicle by utilizing the first three-dimensional position sensor, the second three-dimensional position sensor, and the global positioning system as the vehicle transitions from the starting position to the ending position along the custom path; and
conveying steering instructions on to the remote device, based on the tracking data and the custom path, until the vehicle arrives at the ending point.

18. The computer implemented process for guiding a vehicle of claim 17, wherein conveying steering instructions on to the remote client device, based on tracking data and the custom path, until the vehicle arrives at the ending point further comprises:
steering, autonomously, the vehicle from the starting point to the ending point along the custom path through commands issued by the remote client device and the controller.

19. The computer implemented process for guiding a vehicle of claim 18, wherein conveying steering instructions on to the remote client device, based on tracking data and the custom path, until the vehicle arrives at the ending point further comprises:
calculating a forward-looking path point as the vehicle transitions from the starting position to the ending position along the custom path; and
modifying the conveyed steering instructions based off of the forward-looking path point.

20. A system for guiding a vehicle-assisted trailer, the system comprising:
a remote client device having a graphical user interface (GUI), a controller, and a processor, wherein the remote client device is configured to:
accept positional data from a vehicle and a trailer;
display, on the GUI, a representation of the vehicle and the trailer within a map environment based on the positional data;
create a starting position and an ending map position on the GUI based on inputs from a user of the remote client device;
discriminate between a forbidden area and an acceptable area within the map environment;
calculate a shortest line path between the starting position and the ending position on the map;
verify whether the shortest line path intersects with the forbidden area;
perform a first action if the shortest line path does not intersect with the forbidden area, the first action comprising conveying steering instructions on the GUI, based on the positional data, as the vehicle and trailer transition from the starting position to the ending position along the shortest line path; and
perform a second action if the shortest line path intersects with the forbidden area, the second action comprising:
superimposing an overlay grid on the representation of the vehicle and the trailer within the map environment, wherein each grid point within the overlay grid is associated with a position in the environment;
excluding grid points that are within the forbidden area;
modifying the shortest line path to correspond with grid points within the acceptable area within the environment, thus creating a custom path; and
conveying steering instructions on the GUI, based on the positional data, as the vehicle and trailer transition from the starting position to the ending position along the custom path.

21. The system of claim 20, wherein the remote client device is configured to discriminate between a forbidden area and an acceptable area within the map environment comprises:
creating a buffer around the forbidden area.

22. A system for guiding an autonomous vehicle-assisted trailer, the system comprising:
a remote client device having a controller, and a processor, wherein the remote client device is configured to:
accept positional data from an autonomous vehicle and a trailer within a map environment;
create a starting position and an ending position based on inputs to the remote client device;
discriminate between a forbidden area and an acceptable area within the map environment;
calculate a shortest line path between the starting position and the ending position;
verify whether the shortest line path intersects with the forbidden area;
perform a first action if the shortest line path does not intersect with the forbidden area, the first action comprising transmitting steering instructions to a controller area network (CAN) bus on the autonomous vehicle, based on the positional data, as the autonomous vehicle and trailer transition from the starting position to the ending position along the shortest line path; and
perform a second action if the shortest line path intersects with the forbidden area, the second action comprising:
superimposing an overlay grid on the representation of the autonomous vehicle and the trailer within the map environment, wherein each grid point within the overlay grid is associated with a position in the environment;
excluding grid points that are within the forbidden area;
modifying the shortest line path to correspond with grid points within the acceptable area within the map environment, thus creating a custom path;
transmitting steering instructions to the CAN bus on the autonomous vehicle, based on the positional data, as the autonomous vehicle and trailer transition from the starting position to the ending position along the custom path; and
executing the steering instructions as the autonomous vehicle and trailer transition from the starting position to the ending position along the custom path.
